(19) United States
(12) Patent Application Publication
(10) Pub. No.: US 2009/0174258 A1
(43) Pub. Date: Jul. 9, 2009

(54) Built-in uninterruptible power supply system and electronic device using the same

(75) Inventors: Ta-Wei Liu, Taipei (TW); Shun-Lung Wang, Taipei (TW); Chun-Hao Liao, Taipei (TW); Chao-Ming Chu, Taipei (TW); Chih-Min Huang, Taipei (TW); Hsuan-Wu Wei, Taipei (TW)

Correspondence Address: BACON & THOMAS, PLLC, 625 SLATERS LANE, FOURTH FLOOR, ALEXANDRIA, VA, 22314-1176, US

(73) Assignee: ASUSTek COMPUTER INC., Taipei (TW)

(21) Appl. No.: 12/289,999

(22) Filed: Nov. 10, 2008

(30) Foreign Application Priority Data
Jan. 8, 2008 (TW) 97100751

(51) Int. Cl. H02J 9/00

(52) U.S. Cl. 307/64

(57) ABSTRACT

A built-in uninterruptible power supply system and an electronic device using the same are provided. The built-in uninterruptible power supply system supplies power to an electronic component of an electronic device. The built-in uninterruptible power supply system includes a power supply, a power storage, a power supply switch and a power display. The power supply switch electrically couples the power supply with the power storage. The power supply switch switches to transmit a first power or a second power to the electronic component. The power display is disposed in the casing and electrically coupled with the power storage for displaying a storage power of the power storage. When the external power source stops supplying power to the power supply, the power supply switch switches to transmit the second power from the power storage to the electronic component.

This application claims the benefit of Taiwan application Serial No. 97100751, filed Jan. 8, 2008, the subject matter of which is incorporated herein by reference.

### BACKGROUND OF THE INVENTION

1. Field of the Invention

The invention relates in general to a built-in uninterruptible power supply system and an electronic device using the same, and more particularly to a built-in uninterruptible power supply system which displays power storage on the casing and an electronic device using the same.

2. Description of the Related Art

Uninterruptible power supply (UPS) system prevents the electronic device from data loss and damage caused when power stops or fails abnormally. Also, the UPS system effectively protects the internal elements of the electronic device to assure the lifespan and precision of the electronic device. Besides, when power cut or power failure occurs, the UPS system provides a buffer time for the electronic device to be shut down normally. Currently, the UPS system available in the market is external type, and can be independently installed outside the electronic device such as a computer host and then electrically connected to the electronic device via a cable.

However, external UPS system is normally disposed near the electronic device. If the electronic device is a computer host, the UPS system will occupy the space where the user's feet are placed in and will be easily kicked by the user, hence making the user disturbed. As the UPS system is easily kicked by the user, the UPS system is easily subject to collision and damage.

### SUMMARY OF THE INVENTION

The invention is directed to a built-in uninterruptible power supply system and an electronic device using the same. The built-in uninterruptible power supply system is disposed in a casing of the electronic device, hence improving the convenience of moving the electronic device. Besides, by means of the power display, the user can easily observe the power storage of the electronic device.

According to a first aspect of the present invention, a built-in uninterruptible power supply system for supplying power to an electronic component of an electronic device is provided. The built-in uninterruptible power supply system includes a power supply, a power storage, a power supply switch and a power display. The power supply is disposed in a casing of the electronic device and receives power supplied by an external power source for providing a first power. The power storage is disposed in the casing for providing a second power. The power supply switch electrically couples the power supply with the power storage and is used for switching to transmit the first power or the second power to the electronic component. The power display is disposed in the casing and electrically coupled with the power storage for displaying a storage power of the power storage. When the external power source stops supplying power to the power supply, the power supply switch switches to transmit the second power from the power storage to the electronic component.

According to a second aspect of the present invention, an electronic device including a casing, an electronic component and a built-in uninterruptible power supply system is provided. The built-in uninterruptible power supply system is for supplying power to an electronic component of the electronic device and includes a power supply, a power storage, a power supply switch and a power display. The power supply is disposed in the casing and receives power supplied by an external power source for providing a first power. The power storage is disposed in the casing for providing a second power. The power supply switch electrically couples the power supply with the power storage and is for switching to transmit the first power or the second power to the electronic component. The power display is disposed in the casing and electrically coupled with the power storage for displaying a storage power of the power storage. When the external power source stops supplying power to the power supply, the power supply switch switches to transmit the second power from the power storage to the electronic component.

The invention will become apparent from the following detailed description of the preferred but non-limiting embodiments. The following description is made with reference to the accompanying drawings.

### BRIEF DESCRIPTION OF THE DRAWINGS

FIG. 1 shows an electronic device according to a preferred embodiment of the invention;

FIG. 2 shows a system block diagram of a built-in uninterruptible power supply system according to a preferred embodiment of the invention;

FIG. 3A shows a disposition of a power display in FIG. 1;

FIG. 3B shows another disposition of the power display in FIG. 1; and

FIG. 4 shows the power display in FIG. 1, which is electrically coupled with the power supply.

### DETAILED DESCRIPTION OF THE INVENTION

A built-in uninterruptible power supply system according to the preferred embodiment of the invention is disposed in an electronic device. The built-in uninterruptible power supply system includes a power storage and a power display. The power display is disposed in the casing and displays a storage power of the power storage. The invention is exemplified by a preferred embodiment below. However, the preferred embodiment is only an embodiment under the spirit of the invention, and the explanations and drawings disclosed below are not for limiting the scope of protection of the invention.

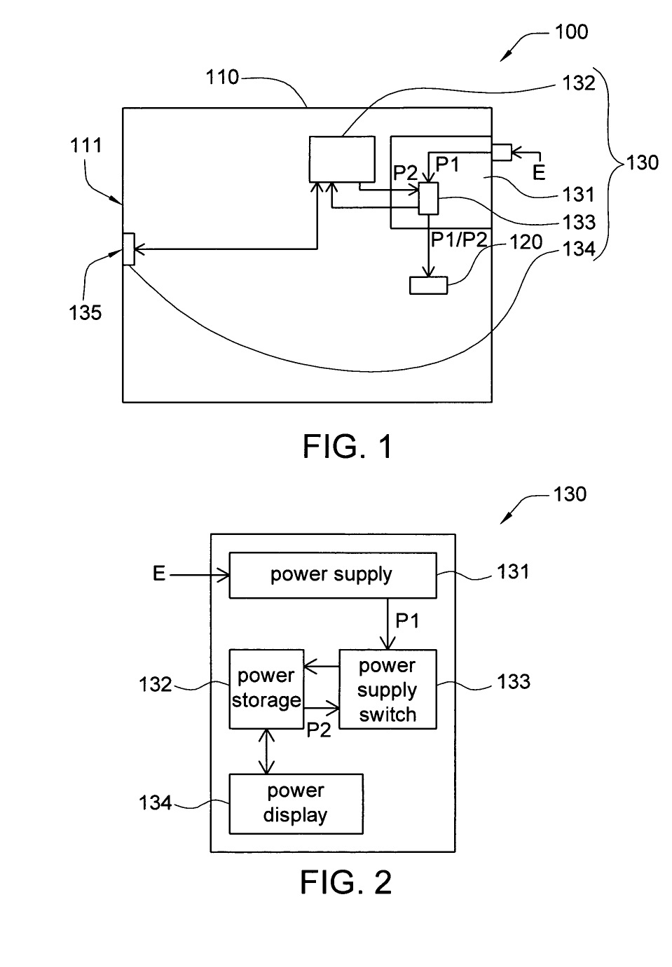

Referring to FIG. 1, an electronic device according to a preferred embodiment of the invention is shown. The electronic device, such as a desktop computer host, includes a casing 110, an electronic component 120 and a built-in uninterruptible power supply system 130. Referring to both FIG. 1 and FIG. 2, FIG. 2 shows a system block diagram of a built-in uninterruptible power supply system according to a preferred embodiment of the invention. The built-in uninterruptible power supply system 130 includes a power supply 131, a power storage 132, a power supply switch 133 and a power display 134. The power supply 131 is disposed in the casing 110 and receives power supplied by an external power source E for providing a first power P1. The power storage 132 is disposed in the casing 110 for providing a second power P2. The power supply switch 133 electrically couples the power supply 131 with the power storage 132. The power supply switch 133 is for switching to transmit the first power P1 or the second power P2 to the electronic component 120. The power display 134 is disposed in the casing 110. Preferably, a surface 135 of the power display 134 is exposed from an outer surface 111 of the casing 110. The power display 134 is electrically coupled with the power storage 132 for detecting and displaying a storage power (not illustrated) of the power storage 132. When the external power source E stops supplying power to the power supply 131 (for example, when power cut or power failure occurs), the power supply switch 133 switches to transmit the second power P2 from the power storage 132 to the electronic component 120. That is, when the external power source E stops power supply, the electronic component 120 can operate normally with the second power P2.

As indicated in FIG. 1, the power display 134 is disposed on the casing 110 of the electronic device 100, not disposed on the casing of the internal components (the power supply 131 or the power storage 132) of the built-in uninterruptible power supply system 130. Thus, the power display 134 can display a storage power of the power storage 132 to inform the user so that the user can react timely when power failure occurs. For example, the user can make a backup or shut down according to normal procedure.

Besides, when the external power source E supplies power to the power supply 131, the power supply 131 transmits the first power P1 to the electronic component 120. That is, when the external power source E provides power normally, the electronic component 120 can operate normally with the first power P1.

Besides, when the external power source E supplies power to the power supply 131 and a storage power is smaller than a predetermined value (for example, the storage power has not reached the full charge status), the power supply 131 charges the power storage 132 through the power supply switch 133 for a storage power of the power storage 132 to achieve a predetermined value. Thus, a storage power of the power storage 132 may maintain at the predetermined value. Besides, the predetermined value denotes the safety power storage to prepare for the emergency. That is, when a storage power maintains at the predetermined value, the external power source E stops power supply, so that the user may have enough time to prepare for the emergency, hence largely reducing the damage caused by power failure or power cut.

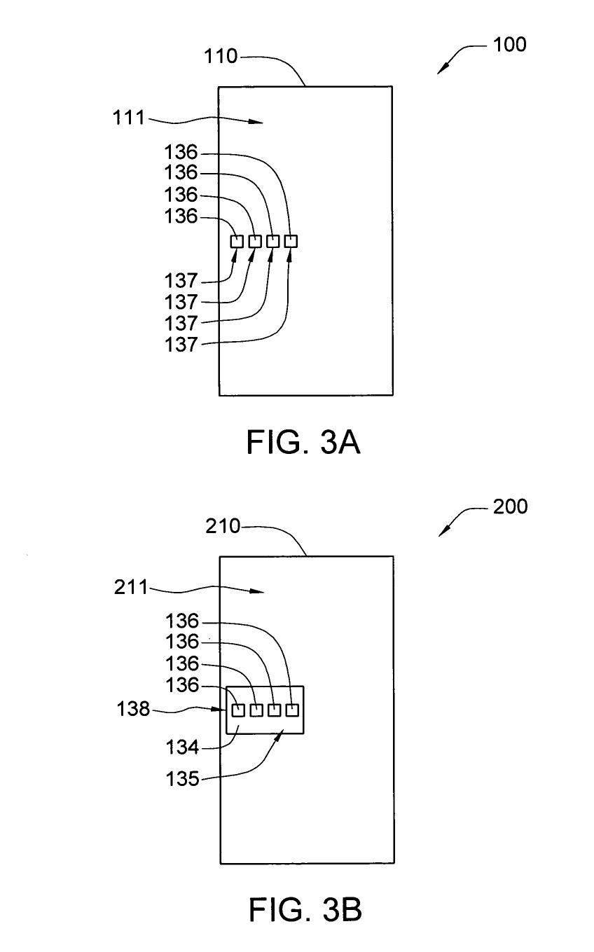

Referring to FIG. 3A, a disposition of a power display in FIG. 1 is shown. The power display 134 has a plurality of light emitting diodes (LEDs) 136 disposed on the surface 135 (the surface 135 is illustrated in FIG. 1) of the power display 134. The more LEDs 136 are turned on, the higher the storage power of the power storage 132 is. To be more precisely, if the LEDs are all turned on, this indicates that the storage power has reached the predetermined value. For example, the predetermined value denotes that the power storage 132 is full-charged.

In the present embodiment of the invention, the casing 110 has a plurality of holes 137 for exposing the holes 137. Thus, the light emitted by the LEDs 136 may pass through the holes 137 for the user to view the state of power storage clearly. Referring to FIG. 3B, another disposition of the power display in FIG. 1 is shown. The electronic device 200 includes a casing 210. An outer surface 211 of the casing 210 has a through opening 138. Thus, no matter the power display 134 is correspondingly disposed on the inner surface of the opening 138 or a part of the power display 134 is embedded into the inner wall of the through opening 138, a plurality of LEDs 136 disposed on the surface 135 are exposed from the through opening 138 so that the user can clearly view the state of power storage.

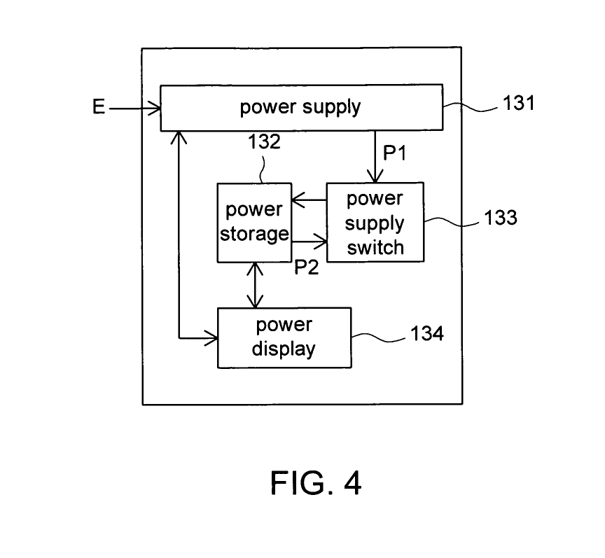

Besides, the power display 134 is further electrically coupled with the power supply 131. As indicated in FIG. 4, the power display in FIG. 1, which is electrically coupled with the power supply, is shown. When the external power source E supplies power to the power supply 131, the power display 134 stops displaying a storage power, hence saving the energy for displaying LEDs 136. Or, when the external power source E supplies power to the power supply 131, the power display 134 displays a storage power, so that the user can clearly view the state of power storage.

The built-in uninterruptible power supply system and the electronic device using the same disclosed in the embodiment of the invention have many advantages exemplified as follows.

Firstly, the built-in uninterruptible power supply system is disposed in the casing of the electronic device and does not occupy external space. Furthermore, there is no need to disassemble the built-in uninterruptible power supply system when moving the electronic device. That is, the built-in uninterruptible power supply system is also moved when the electronic device is moved, hence increasing the convenience and portability of the electronic device.

Secondly, the outer surface of the casing of the power display disposed in the electronic device is exposed, so that the user can easily view the power storage of the electronic device and prepare for the emergency when external power source stops or fails.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A built-in uninterruptible power supply system for supplying power to an electronic component of an electronic device, wherein the electronic device has a casing, and the built-in uninterruptible power supply system comprises:
a power supply disposed in the casing, for receiving power supplied by an external power source for providing a first power;
a power storage disposed in the casing, for providing a second power;
a power supply switch electrically coupling the power supply with the power storage, for switching to make the first power or the second power transmit to the electronic component; and
a power display disposed in the casing and electrically coupled with the power storage, for displaying a storage power of the power storage;
when the external power source stops supplying power to the power supply, the power supply switch switches, and then the second power is transmitted from the power storage to the electronic component.

2. The built-in uninterruptible power supply system according to claim 1, wherein when the external power source stops supplying power to the power supply, the power display displays the storage power.

3. The built-in uninterruptible power supply system according to claim 1, wherein when the external power source supplies power to the power supply, the power supply transmits the first power to the electronic component.

4. The built-in uninterruptible power supply system according to claim 1, wherein when the external power source supplies power to the power supply and the storage power is smaller than a predetermined value, the power supply charges the power storage through the power supply switch.

5. The built-in uninterruptible power supply system according to claim 1, wherein a surface of the power display is exposed from an outer surface of the casing.

6. The built-in uninterruptible power supply system according to claim 5, wherein the power display has a plurality of light emitting diodes (LEDs) disposed on the surface of the power display;
wherein the more LEDs are turned on, the higher the storage power of the power storage is.

7. The built-in uninterruptible power supply system according to claim 6, wherein the LEDs are all turned on to indicate that the power storage is full-charged.

8. The built-in uninterruptible power supply system according to claim 6, wherein the power display is further electrically coupled with the power supply, and when the external power source supplies power to the power supply, the LEDs are all turned on to indicate that the system is full-charged.

9. The built-in uninterruptible power supply system according to claim 6, wherein the power display is further electrically coupled with the power supply, when the external power source supplies power to the power supply, the power display stops displaying the storage power.

10. An electronic device, comprising:
a casing;
an electronic component disposed in the casing; and
a built-in uninterruptible power supply system for supplying power to the electronic component of the electronic device, wherein the built-in uninterruptible power supply system comprises:
a power supply disposed in the casing, for receiving power supplied by an external power source for providing a first power;
a power storage disposed in the casing for providing a second power;
a power supply switch electrically coupling the power supply with the power storage, for switching to make the first power or the second power transmit to the electronic component; and
a power display disposed in the casing and electrically coupled with the power storage, for displaying a storage power of the power storage;
when the external power source stops supplying power to the power supply, the power supply switch switches, and then the second power is transmitted from the power storage to the electronic component.

11. The electronic device according to claim 10, wherein when the external power source stops supplying power to the power supply, the power display starts to display the storage power.

12. The electronic device according to claim 10, wherein when the external power source supplies power to the power supply, the power supply transmits the first power to the electronic component.

13. The electronic device according to claim 10, wherein when the external power source supplies power to the power supply and the storage power is smaller than a predetermined value, the power supply charges the power storage through the power supply switch.

14. The electronic device according to claim 10, wherein a surface of the power display is exposed from an outer surface of the casing.

15. The electronic device according to claim 14, wherein the power display has a plurality of light emitting diodes (LED) disposed on the surface of the power display;
wherein the more LEDs are turned on, the higher the storage power of the power storage is.

16. The electronic device according to claim 15, wherein the LEDs are all turned on to indicate that the power storage is full-charged.

17. The electronic device according to claim 15, wherein the power display is further electrically coupled with the power supply, and when the external power source supplies power to the power supply, the LEDs are all turned on to indicate that the system is full-charged.

18. The electronic device according to claim 15, wherein the power display is further electrically coupled with the power supply, and when the external power source supplies power to the power supply, the power display stops displaying the storage power.

19. The electronic device according to claim 10, wherein the electronic device is a desktop computer host.
